(19) United States
(12) Patent Application Publication
(10) Pub. No.: US 2006/0115634 A1
(43) Pub. Date: Jun. 1, 2006

(54) Resin coated papers with imporved performance

(76) Inventors: Chang Shin Park, San Diego, CA (US); Xulong Fu, San Diego, CA (US); Ronald J. Selenskly, San Diego, CA (US); Christine E. Steichen, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/260,585

(22) Filed: Oct. 27, 2005

Related U.S. Application Data
(63) Continuation of application No. 11/002,156, filed on Nov. 30, 2004.

(51) Int. Cl. B41M 5/00

(52) U.S. Cl. 428/195.1

(57) ABSTRACT

An image supporting medium having improved image performance such as gloss, including a raw base paper and a film forming resin disposed on at least one side of the raw base paper.

### RELATED APPLICATOINS

This application is a continuation in part of application Ser. No. 11/002,156 filed Nov. 30^{th}, 2004, entitled “A System and Method for inkjet Image Supporting Medium,” assigned the assignee of the present invention, the full disclosure of which is hereby incorporated by reference in its entirety.

### FIELD OF THE INVENTION

The present invention generally relates to base papers, and in particular, to resin coated photo base papers with improved image performance.

### BACKGROUND OF THE INVENTION

The use of digital image-forming apparatus such as, thermal inkjet printers, piezo-electric printers, desktop printers, large format printer, and laser printers, has grown in recent years. The growth may be attributed to substantial improvements in print resolution and overall print quality coupled with appreciable reduction in cost, and ease of use. Today's image-forming apparatus offer acceptable print quality for many commercial business and household applications at costs lower than those offered in the past.

Media products for receiving printed images are used in conjunction with these image-forming apparatus. Known imaging and printing media often include a base paper, coated with a single or multi-layer functional coating, such as ink receiving layer, curl balancing layer, and image protection layer. The base paper can be either uncoated raw base paper, coated base paper, or resin coated photo base paper.

A resin coated photo base paper used for photo printing has traditionally included a raw base paper configured for silver halide photo media. Base paper configured for silver halide photo media is a high quality paper that is specially made for forming prints using negatives. Further, traditional image supporting media are typically made waterproof by extruding plastic layers, usually polyolefin resins such as polyethylene, on both sides. Normally, the resin coating on the top layer contains at least one or more of a white pigment, fluorescent dyestuff and shading dyes, in order to enhance or attain the impression of increased whiteness.

The image receiving side is coated with a number of light-sensitive silver-halide grains that are spectrally sensitized to red, green and blue light for color printing or a number of silver-halide grains that are sensitive to monochromatic light exposure for black and white printing. Traditionally, the image supporting media also include gelatin that physically secures the silver-halide grains and facilitates formation of an image.

Conventional silver halide photo base paper has very strict quality requirements due to the complex image developing process, resulting in increased production cost when compared to ordinary fine base paper. For example, silver halide grade raw base paper requires minimum edge liquid penetration and contains an extremely high content of sizing material such as AKD (Alkylketone Dimer). Furthermore, silver halide grade raw base paper is adversely affected by the use of minerals (typically used as fillers) such as calcium carbonate which may cause possible chemical reactions with the developing liquid. Silver halide grade raw base paper also has requirements regarding the manufacturing process and equipment, as for example, being formed on machines made of stainless steel to prevent iron sensitization of the silver halide emulsion, and relatively slow forming process rates of typically six hundred (600) meters per minute (m/min).

While many of the above-mentioned costs are attributed to preparing the image supporting medium for use with a silver halide developing process, the relatively expensive silver halide image supporting medium is often used with non-silver halide image forming processes, resulting in an unduly expensive and over-engineered image supporting medium for these other processes.

It would be desirable to provide image supporting media for use in ink jet printers with lower material cost and higher manufacturing ease while maintaining key photo quality attributes of a photo base paper.

### SUMMARY OF THE INVENTION

The present invention is directed to a medium (“substrate”) usable in inkjet printing apparatus (either or both piezoelectric and thermal inkjet, or other forms of inkjet printing). In one embodiment, the substrate is an image supporting medium comprising a raw base paper, at least one filler, and a film forming resin disposed on at least one side of the raw base paper. According to the present invention, the raw base paper scale of formation ranges from about 0.5 to about 12.0 mm; generally from about 0.5 to about 0.7 mm (“C1”), from 0.7 to about 1.1 mm (“C2”), from about 1.1 to about 1.8 mm (“C3”), from about 1.8 to about 2.6 mm (“C4”), from about 2.6 to about 4.5 mm (“C5”), from about 4.5 to about 6.7 mm (“C6”), and from about 6.7 to about 12.0 mm (“C7”), wherein the C1 through C7 refer to the scales of formation as defined by the PaperPerFect (PPF) analyzer machine, described further below.

In an embodiment, a minimum formation value for each of the scales of formation C2 through C6 is, independently; at least about 65 or at least about 70, at least about 50 or at least about 60, at least about 55 or at least about 60, at least about 60 or at least about 70, and at least about 70 or at least about 80; respectively.

In an embodiment an image supporting medium, comprises a raw base paper having at least one filler in an amount ranging from about 1 to about 40 wt. % and a moisture content of up to about 8.5 wt. %, and a film forming resin disposed on at least one side of the raw base paper.

### BRIEF DESCRIPTION OF THE DRAWINGS

FIG. 1 is a cross-sectional view of an image supporting medium embodying features of an embodiment of the invention.

FIG. 2 is a graphical representation demonstrative of the correlations between formation scale and gloss level.

FIG. 3 is a flow chart illustrating a method for forming a coated photo inkjet paper, according to an exemplary embodiment.

FIG. 4 is a simple block diagram illustrating a manufacturing system configured to produce a coated photo inkjet paper, according to one exemplary embodiment.

### DETAILED DESCRIPTION OF EMBODIMENTS OF THE INVENTION

The present invention is directed to a medium (“substrate”) usable in inkjet printing apparatus (either or both piezoelectric and thermal inkjet, or other forms of inkjet printing). In one embodiment, the substrate is a raw base paper usable in the manufacture of “image supporting medium.” In one embodiment, the substrate is an image supporting medium (herein after interchangeably referred as a “resin coated photo base paper”) usable in the manufacture of a “coated photo inkjet paper.” In yet another embodiment, the substrate is a “printed substrate” that is at least partially covered with inkjet ink. The present invention is further directed to “inkjet printing systems,” including either or both printer and “inkjet pens,” for use with, or with which, such substrate is usable. The substrates of the present invention provide for enhanced gloss and image quality in either or both the image supporting medium (i.e., resin coated photo base paper) and the final coated photo inkjet paper.

The substrate may be used to print images (i.e., creating “printed substrate”) using commercially available inkjet printers from a number of manufacturers. The inkjet printers include, by way of example, piezo and thermal inkjet printers, both desk top and large format. Examples include Deskjet®, Business Inkjet, Photosmart® Inkjet, and Designjet® printers, all manufactured by Hewlett-Packard Company of Delaware.

The photo base paper according to the present invention, includes a raw base paper formed from fibers, fillers, moisture, and optional additives, and film forming resin disposed on at least one side of the raw base paper. In an embodiment the filler content of the raw base paper constitutes up to about 40%, generally from about 1 to about 40 wt. %, usually from about 5 to about 35 wt. %, normally from about 10 to about 25 wt %, based on the basis weight of the base paper. A corona treatment may be utilized to enhance the adhesion of the resin on the surface of the raw base paper. After the resin coating is complete, a gelatin subbing layer may be applied to enhance the adhesion of photo inkjet coating formulation on the resin coated surface. Additionally, anti-static layer can be applied at the back side of the photo base paper.

According to one embodiment of the present invention, there is a correlation, generally a strong correlation, between the small scale formation of the raw base paper and its gloss level, and the gloss level of subsequent resulting papers, namely, the photo base paper, the coated inkjet paper, and the printed substrate. According one embodiment, the raw base paper scale of formation ranges from about 0.5 to about 12.0 mm; generally from about 0.5 to about 0.7 mm (“C1”), from 0.7 to about 1.1 mm (“C2”), from about 1.1 to about 1.8 mm (“C3”), from about 1.8 to about 2.6 mm (“C4”), from about 2.6 to about 4.5 mm (“C5”), from about 4.5 to about 6.7 mm (“C6”), and from about 6.7 to about 12.0 mm (“C7”), wherein the C1 through C7 refer to the scales of formation as defined by the PaperPerFect (PPF) analyzer machine, described further below. Among the stated scales of formation, in one embodiment, scales C2 through C6 have a greater correlation to gloss than the rest of the stated C ranges.

According to an embodiment, there exists minimum PaperPerFect formation values (PPFV), for different scales of formation (size ranges), which have to be maintained in order to yield acceptable gloss levels for the subsequent substrates including the photo base paper and the coated photo inkjet paper. The methodology is described further below.

In an embodiment, the minimum formation uniformity values for each scale of formation, either or both independently and together is: 105, 70, 60, 55, 50, 65 and 65; for formation scales of C1 through C7; respectively. In one embodiment, the minimum formation uniformity values are: 110, 80, 70, 60, 60, 70, and 70; for C1 through C7 respectively. The greater the number of the C groups which meet their minimum numbers, the better the gloss will be. In one embodiment, all the minimum numbers are met for the stated C groups.

According to one exemplary embodiment, in order to optimize the gloss of the image supporting medium and the coated photo inkjet paper, the raw base paper has a moisture content of less than about 8.5 wt. %, generally 8.0 wt. % or less, usually ranging from about less than 8.0 wt. %, often ranging from about 7.0 wt. % or less, normally ranging from about 6.0 to about 7.0 wt. %, as compared to the basis weight of the base paper. In one embodiment, the moisture levels indicated above are at a filler content ranging from about 10.0 to 20.0 wt. % as compared to the basis weight of the base paper.

### DEFINITIONS

As used in this specification and in the appended claims, the following terms have the following meanings:

A “raw base paper” is meant as any unextruded or uncoated paper that includes fibers, fillers, additives, etc., used to form a photo base paper.

An “image supporting medium” or “photo base paper” will be used interchangeably and is meant as a “resin coated” raw base paper that has no inkjet coating formulation disposed thereon.

A “coated photo inkjet paper” is meant as a photo base paper that includes an inkjet formulation coated thereon resulting in a finished medium that can be imaged with an inkjet printer.

A “printed substrate” is meant as a coated photo inkjet paper that is at least partially covered with inkjet ink.

A “substrate” is meant as any one of “raw base paper,” “image supporting medium” or “photo base paper,” “coated photo inkjet paper,” or “printed substrate,” which includes features of the present invention.

A “Silver halide” is meant as any compound made up of silver and a halogen such as chlorine, bromine, or occasionally iodine.

A “resin” is meant as any viscous substance (at its melt processing temperature) that is substantially transparent or translucent yet not soluble in water.

The term “brightness” is meant as a medium's directional reflectance relative to the reflectance from a standard, such as magnesium oxide, at a light wavelength of 457 nm.

The term “fiber length” (FL) is meant broadly as weighted average fiber length of a pulp after a refining process. Accordingly, if fiber length is/mm (millimeter) and weighs w mg (milligram), then for a given pulp, the weighted average length (L) is Σ(wl)/Σw, or the sum of the products of the weight times the length of each fiber divided by the total weight of the fibers in the specimen.

In addition, as used herein “inkjet pen” is meant as an inkjet pen including or configured to include inks; “printing system” is meant as an inkjet printing system configured to use the substrate of the present invention and includes at least one or more of inkjet ink, inkjet pen, substrate, and printer. As used herein, inkjet pen includes the inkjet pens where the printhead is attached to the ink supply and both the printhead and the ink supply are disposable on the moving carriage that traverses across the paper (“on-axis” system), as well as where the printhead is disposed permanently or semi-permanently on the carriage and the printhead is removably connectable to an ink supply which is disposed remote to the carriage (e.g., not on the movable carriage, i.e., “off-axis”).

In an embodiment the present invention is directed to “inkjet printing systems,” including either or both printer and “inkjet pens,” for use with, or with which, such substrate is usable.

All concentrations herein are in weight percent of the stated material in basis weight, unless otherwise indicated. By way of example, to describe the weight percentage of filler material or moisture, the weight of the material (e.g., filler or water) is divided by total basis weight (which includes the weight of the materials, moisture and fiber) For example, for 100 g total basis weight base paper, 5% moisture and 15% filler corresponds to a raw base paper containing 5 grams (g) of water, 15 g of filler, and 80 g of fiber. The purity of all components is that employed in normal commercial practice for printing media, unless otherwise stated.

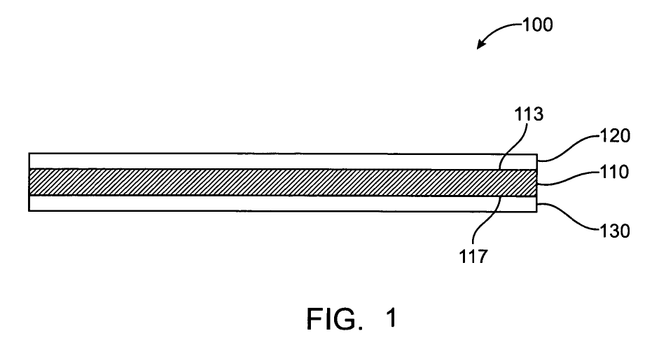

Now referring to FIG. 1, it is a schematic illustration of an exemplary image supporting medium 100 embodying features of the present invention, including a raw base paper layer 110. In an embodiment, the raw base paper 110 has two surfaces; 113 and 117, respectively; extending away from one another on opposite sides of the raw base paper layer 110, with at least one resin layer 120 disposed adjacent at least one such surface thereof. According the embodiment shown in FIG. 1, the supporting medium 100 further includes at least one other resin layer 130 disposed adjacent the second surface thereof. In an embodiment, either or both the resin layers 120 and 130 are film forming resin layers. The resin layer 120 and/or 130, each can independently be disposed adjacent the raw base paper 110, by suitable means, such as but not limited to, coating, spraying, lamination or extrusion.

In one exemplary embodiment, the at least one film forming resin 120 and/or 130, each independently when present, is formed from thermoplastic resin such as a polyolefin resin, polycarbonate resin, a polyester resin, a polyamide resin, or mixtures thereof. In one embodiment, the thermoplastic resin is a polyolefin resin the form from a polyethylene resin. Herein after for purposes of describing the resin forming layer, layer 120 will be used. It should be understood that any description relating to layer 120 may also apply to layer 130 (when present). When used, the polyethylene resin is particularly useful due to its melt-extrusion capability. In an embodiment, the polyethylene resin is selected from the group consisting of low-density polyethylene, medium-density polyethylene, high-density polyethylene, straight chain low density polyethylene, copolymers with alpha-olefins (e.g., ethylene and propylene, or butylenes), carboxy-modified polyethylene resins, and mixtures thereof.

The raw base paper 110 may be formed from any number of types of fiber, including, but not limited to, virgin hardwood, virgin softwood, recycled hardwood, recycled softwood fibers, and combinations thereof.

In an embodiment, the fiber length (FL) of the raw base paper 110 may be about 3.0 millimeters (mm) or less in weighted average length. In one embodiment, the fiber length (FL) may range from about 0.5 mm to about 3.0 mm after the completion of the pulp refining process.

In an embodiment, the raw base paper 110 may include a number of filler and additive materials, as may be necessary in the practice of the invention. Exemplary fillers and additives useful in the practice of the invention include, but are not limited to, clay, kaolin, calcium carbonate (CaCO₃), gypsum (hydrated calcium sulfate), titanium oxide (TiO₂), talc, alumina trihydrate, magnesium oxide (MgO), minerals, synthetic fillers, natural fillers, and combinations thereof, or any other material suitable to act as filler in place of or in addition to cellulose fibers in the making of the image supporting medium 100.

In one exemplary embodiment, up to and including about forty percent (40%) of the basis weight of the raw base paper 110 may be made up of filler. In an embodiment the filler content of the raw base paper ranges from about 1 to about 40 wt. %, usually from about 5 to about 35 wt. %, normally from about 10 to about 25 wt % based on basis weight of the raw base paper. In one embodiment, the filler is a mineral filler such as calcium carbonate. As can be appreciated, the inclusion of filler reduces the overall cost of image supporting medium 100, while maintaining and/or enhancing the quality of the image supporting medium 100 and subsequent media or substrates resulting from the same, such as the coated photo inkjet paper.

By way of example, white filler, such as calcium carbonate enhance the brightness, whiteness, and the quality of the resulting image supporting medium. The replacement (partial or full) of relatively more expensive fillers such as titanium dioxide, or with relatively lower cost fillers such as calcium carbonate, also contributes to the overall cost savings in the manufacture of the image supporting medium.

In an embodiment of the present invention, it was found that there is a correlation, generally a strong correlation, between the small scale formation of the raw base paper and the gloss level of the raw base paper, and the subsequent resulting papers, namely, the photo base paper, the coated inkjet paper, and the printed substrate. The raw base paper scale of formation found to have this impact ranges from about 0.5 to about 12.0 mm. In one series of experiments it was found that the following raw base paper scale of formation, either or both independently and together, usually together, have an effect, generally a significant effect, on the gloss: from about 0.5 to about 0.7 mm (C1), from 0.7 to about 1.1 mm (C2), from about 1.1 to about 1.8 mm (C3), from about 1.8 to about 2.6 mm (C4), from about 2.6 to about 4.5 mm (C5), from about 4.5 to about 6.7 mm (C6), and from about 6.7 to about 12.0 mm (C7); wherein the C1 through C7 refer to the scales of formation as defined by the PaperPerFect analyzer machine, described further below. Among the stated scales of formation, in one embodiment, it was found, that scales C2 through C6 have a greater impact on gloss than the rest of the stated C groups.

In an embodiment, it was further discovered that there exists minimum formation values (PPFV), for different size ranges, which have to be maintained in order to yield acceptable gloss levels for the subsequent substrates including the coated photo base paper and the coated photo inkjet paper. The methodology is described further below.

In an embodiment, in order to optimize the gloss of the photo base paper and the coated photo inkjet paper, the formation uniformity of the raw base paper has a minimum formation uniformity value, definable as PPF Formation Value (PPFV), for different scales of formation (size ranges). In an embodiment, each of the minimum formation uniformity values for each scale of formation size, independently is as follows, while in an embodiment, all the minimum formation uniformity numbers are met for the various scales of formation listed below in table 1:

TABLE I

| | |
|---|---|
| Minimum Formation | |
| Uniformity (“MPPFV”) | Scale of Formation |

| Generally | Usually | (“SF”) or Formation Scale (FS) |
|---|---|---|
| 100 | 105 | C1 (0.5˜0.7 mm) |
| 70 | 80 | C2 (0.7˜1.1 mm) |
| 60 | 70 | C3 (1.1˜1.8 mm) |
| 55 | 60 | C4 (1.8˜2.6 mm) |
| 50 | 60 | C5 (2.6˜4.5 mm) |
| 65 | 70 | C6 (4.5˜6.7 mm) |
| 65 | 70 | C7 (6.7˜12.0 mm) |

In one exemplary embodiment, it was surprisingly found that the moisture level of the raw base paper particularly had an effect on the gloss of the photo base paper, and the subsequent substrates formed therefrom. According to one exemplary embodiment, in order to optimize the gloss of the image supporting medium and the coated photo inkjet paper, the raw base paper 110 has a moisture content of less than about 8.5 wt. %, generally 8.0 wt. % or less, usually ranging from about less than 8.0 wt. %, often ranging from about 7.0 wt. % or less, normally ranging from about 6.0 to about 7.0 wt. %, as compared to the basis weight of the raw base paper. In one embodiment, the moisture levels indicated above are at a filler content ranging from about 10.0 to 20.0 wt. %, as compared to the basis weight of the raw base paper.

In an embodiment, it was found that moisture levels higher than those stated adversely affect the gloss of the either or both the photo base paper, and the subsequent substrates including the coated photo inkjet paper.

In one embodiment, additives may be optionally added to the raw base paper 110. Suitable examples of such additives include, but are not limited to, sizing agents such as metal salts of fatty acids and/or fatty acids, alkyl ketene dimer emulsification products and/or epoxidized higher fatty acid amides; alkenyl or alkylsuccinic acid anhydride emulsification products and rosin derivatives; dry strengthening agents such as anionic, cationic or amphoteric polyacrylamides, polyvinyl alcohol, cationized starch and vegetable galactomannan; wet strengthening agents such as polyaminepolyamide epichlorohydrin resin; fixers such as water-soluble aluminum salts, aluminum chloride, and aluminum sulfate; pH adjustors such as sodium hydroxide, sodium carbonate and sulfuric acid; optical brightening agents; and coloring agents such as pigments, coloring dyes, and fluorescent brighteners; and combinations thereof.

In one embodiment, up to about twenty percent (20 wt. %) of the raw base paper 110, as compared to the basis weight of the raw base paper, may comprise of fine content having particle size ranging from about 0.2 to about 0.5 microns. Examples of fine content include chopped or fragmented small woody fiber pieces formed during the refining process of the pulp. According to one exemplary embodiment, the fine content may range, as percentage of the total dry weight of the raw base paper, from about 15 to about 20 wt. %, as compared to the basis weight of the raw base paper.

In one embodiment, the raw base paper may include any number of retention aids, drainage aids, wet strength additives, defoamers, biocides, dyes, and other wet-end additives, or combinations thereof.

For purposes of the discussion of examples, the following background information may be useful:

It is generally believed that in the production of a photo base paper, the most critical raw base paper properties are formation and smoothness. Smoothness can be defined as the surface uniformity of paper. Formation can be defined as the small scale variation of mass distribution within a sheet of paper. Smoothness is typically measured by air-leak test method such as Parker Print Surf or Sheffield, while formation evaluation is more complex due to the scale of uniformity.

The quality of formation is typically evaluated by human eyes or formation instruments such as Kajaani, MK, or Ambertec which provide single number formation indexes. The single index number is typically calculated from the coefficient of variation or standard deviation. The single number index has limitations in describing the complexity of the structure of a paper sheet, and often inadequate to predict many of the desired attributes required for photo quality media.

Most Formation instruments using light transmission method, provide two-dimensional light intensity maps projected from the sheet. Similarly beta ray method also provides two-dimensional fiber mass distribution profile. Collapsing two dimensional data into a single number formation index loses technical details of the paper characteristics.

In the present invention, as further described below, the PaperPerFect Formation (PPF) Analyzer available from OpTest Equipment Inc. Ontario, Canada; was used to evaluate the effect of scale of formation on gloss performance.

### EXAMPLES

In order to evaluate the effectiveness of the present invention on gloss, in particular the scale of formation and moisture content, first the properties of a raw base paper having the properties, stated below, were measured and compared to those of a traditional silver halide raw base paper, the results of which are represented in Tables II:

TABLE II

| | MEDIA I | MEDIA II | |
|---|---|---|---|
| | RAW BASE | RAW BASE | MEDIA III |
| | PAPER | PAPER | (CONTROL) |
| | EMBODYING | EMBODYING | SILVER |
| PHYSICAL | FEATURES | FEATURES | HALIDE |
| AND OPTICAL | OF THE | OF THE | BASE |
| PROPERTIES | INVENTION | INVENTION | PAPER |
| PPFV | N/A | See Table I | N/A |
| Moisture (%) | 4%˜8% | 4%˜8% | N/A |
| Gurley | 180 seconds or | 180 seconds or | 180 seconds or |
| Porosity - | lower | lower | higher |
| 100 cc | | | |
| Cobb Test with | 25 grams/m² or | 25 grams/m² or | 25 grams/m² or |
| 2 Minutes | higher | higher | lower |
| Contact Time | | | |
| MD/CD | 1.5˜3.0 | 1.5˜3.0 | 2˜2.5 |
| Stiffness | | | |
| Ratio | | | |
| Brightness per | 95˜110 | 95˜110 | 93˜97 |
| Tappi Standard | | | |
| 525 | | | |
| CIE Whiteness | 105˜140 | 105˜140 | 96˜105 |
| per Tappi | | | |
| Standard 560 | | | |
| Opacity per | 95 or higher for | 95 or higher for | 93 or lower for |
| Tappi Standard | 160 gram/m² | 160 gram/m² | 160 gram/m² |
| 425 | | | |
| Uniformity of | 110˜120 | 110˜120 | >110 |
| Formation | | | |
| using Kajaani | | | |
| Formation | | | |
| Uniformtiy of | 0.25˜0.6 | 0.25˜0.6 | <0.5 |
| Formation | | | |
| using Ambertec | | | |
| Sheffield | 20˜70 SU | 20˜70 SU | <40 SU |
| Smoothness | | | |
| (SU) | | | |
| Park | 2.0˜4.0 | 2.0˜4.0 | 1˜3 |
| Smoothness | | | |
| (microns) | | | |

The various properties were measured according to industry standard methods and/or as further described below.

Scale of formation for the same samples (raw base paper) was measured using the PaperPerFect Formation (PPF) Analyzer available from OpTest Equipment Inc. Ontario, Canada. The PaperPerFect analyzer is a light-transmission formation meter and is capable of measuring the formation scale of paper ranging from 0.5 to 60 mm. The PPF analyzer measures the formation characteristics of a sample by partitioning the sample into its components as a function of scale of formation, over scale of formation range indicated above. The ranges are grouped into ten component groups of C1 to C10 as shown in Table III below:

TABLE III

| Component | Scale of Formation |
|---|---|
| C1 | 0.5˜0.7 mm |
| C2 | 0.7˜1.1 mm |
| C3 | 1.1˜1.8 mm |
| C4 | 1.8˜2.6 mm |
| C5 | 2.6˜4.5 mm |
| C6 | 4.5˜6.7 mm |
| C7 | 6.7˜12.0 mm |
| C8 | 12.0˜18.5 mm |
| C9 | 18.5˜31.0 mm |
| C10 | 31.0˜60.0 mm |

In making the measurement, the instrument uses Fourier Transform-based power spectrum analysis in partitioning the intensity of the non-uniformity of the formation into its components as a function of the scale of formation. Normally, a 256 by 256 pixel image is extracted from the original sample, and subjected to the mirroring and Fast Fourier Transform (FFT) subroutines of the machine. The machine then provides wavelength numbers which directly relate to the dimension of the local non-uniformity in the plane of the sheet. The results are then expressed as PPF Formation Values (PPFV) which are relative to a “perfect paper” (having formation value of 1000 at each component, e.g. different C size range).” The test method is described in detail in U.S. Pat. No. 6,301,373, assigned to McGill University, the full disclosure of which is incorporated herein by reference.

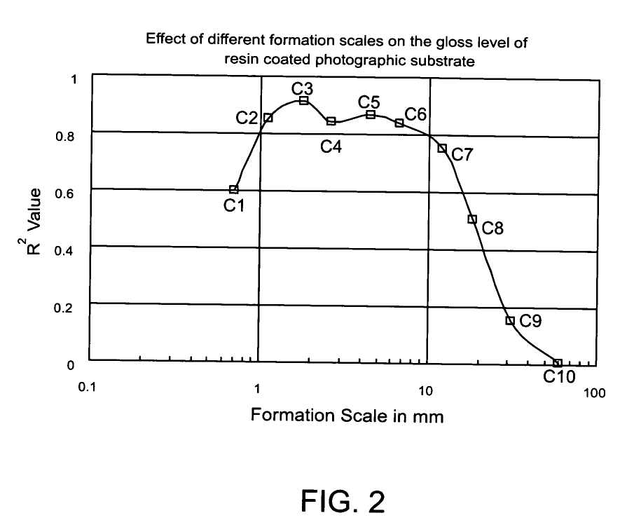

To conduct the test, samples of the base paper 110 as shown in Table II were utilized for processing using the above-referenced commercial machine and method. The samples, generally tested had a scale of formation according to Table III above. The samples were then processed into a photo base paper and the gloss level was measured and the results are reported in Table IV below. The results were analyzed using regression analysis and the coefficients of determination R² (coefficient of determination is a measure of how well the regression line represents the data) for the samples having various scales of formation is reported in FIG. 2. As can be seen from this data, there exists a strong correlation between the different scales of formation C1 through C7 on the property of gloss, in particular scales of formations C2 through C6.

The raw bases samples according to the present invention having scales of formation ranging from C1 to C7 were analyzed, using the above-referenced commercial machine and method, to determine the level of formation uniformity in a raw base paper 110 which was necessary to reach acceptable gloss levels for a resin coated paper (and subsequent substrates formed therefrom). The samples were processed into a photo base paper and the gloss levels were determined.

Gloss level was measured using a Micro-TR1-Gloss Meter (manufactured by BKY-Gardner) at 20° reflection angle (unless otherwise stated). The results of the study are expressed as minimum PPFV (MPPFV) and presented in Table I above, indicating the minimum formation numbers generally necessary for the raw base paper for the identified scales of formation, in order to have acceptable gloss for the photo base paper and the subsequent substrates. The gloss level for the resin coated paper samples and PPFV for the raw base paper were measured and reported in Table IV.

TABLE IV

| | Scale of Formation | | | | | | | | | | % Gloss Resin |
|---|---|---|---|---|---|---|---|---|---|---|---|
| | C1 | C2 | C3 | C4 | C5 | C6 | C7 | C8 | C9 | C10 | Coated Paper |
| Sample ID | Formation Value (PPFV) of Raw Base Paper | | | | | | | | | | at 20° |
| F1 | 112.2 | 71.6 | 56.7 | 48.4 | 49.7 | 53 | 53.9 | 48.8 | 47.1 | 28.7 | 49.8 |
| F2 | 114.2 | 75.8 | 62.6 | 56.4 | 56 | 66.6 | 66.1 | 60 | 61.5 | 31.7 | 51.1 |
| F3 | 101.7 | 68.5 | 56.8 | 50.7 | 50.9 | 59.4 | 57.3 | 49.7 | 41.6 | 25.7 | 48.7 |
| F4 | 110.2 | 76.2 | 65 | 56.6 | 56.8 | 68.3 | 66 | 51.8 | 51.7 | 25.8 | 59.4 |
| F5 | 115.5 | 81 | 67.8 | 60.0 | 60.3 | 71.9 | 74.6 | 61.8 | 55.1 | 27.2 | 62.8 |
| F6 | 122 | 86.7 | 73.6 | 64.4 | 65.2 | 72.3 | 72.3 | 58.5 | 59.9 | 26.4 | 63.5 |
| F7 | 121.6 | 83 | 71.8 | 65.2 | 64.7 | 75.9 | 71.6 | 57.1 | 45.8 | 35 | 64.1 |
| F8 | 119.2 | 84.9 | 74.5 | 65 | 64.9 | 79.8 | 71.6 | 64.1 | 57.2 | 27.9 | 68.6 |
| Corr'n | 0.77 | 0.92 | 0.96 | 0.92 | 0.93 | 0.92 | 0.87 | 0.71 | 0.39 | 0.09 | — |
| R² | 0.60 | 0.85 | 0.91 | 0.84 | 0.87 | 0.84 | 0.75 | 0.51 | 0.15 | 0.01 | — |

Raw base paper samples having the properties stated in Table II, were also processed to yield different moisture levels, and were used to make resin coated papers. The moisture content was measured by either in-line moisture sensor or off-line oven method. The gloss level for the resin coated paper samples was measured and reported in Table V. It was found that raw base papers 110 according to the present invention having a moisture content of 8.5 wt. %, generally 8.0 wt. % or less, usually ranging from about less than 8.0 wt. %, often ranging from about 7.0 wt. % or less, normally ranging from about 6.0 to about 7.0 wt. %, as compared to the basis weight of the raw base paper, provided the best gloss performance for the resin coated paper if the raw base paper met the minimum PPFV requirement stated in Table I. In one embodiment, the moisture levels indicated above are at a filler content ranging from about 10 to 25 wt %, as compared to the basis weight of the raw base paper. As can be noted from the data in Table V, samples meeting the minimum PPFV and the moisture content according to the present invention provided for a relative gloss improvement of 10 to 15% at 20° reflection.

TABLE V

| | | Minimum PPFV | Resin Coated | |
|---|---|---|---|---|
| | Moisture | requirement | Paper Gloss | Filler |
| | Content | Met or not? | at 20° | Content |
| M0 | 3.5% | No | 58.0% | 0% |
| M1 | 5.5% | No | 55.1% | 25% |
| M2 | 6.2% | Yes | 62.8% | 15% |
| M3 | 7.2% | Yes | 63.5% | 15% |
| M4 | 8.4% | Yes | 50.1% | 15% |
| M5 | 8.5% | Yes | 49.8% | 15% |
| M6 | 8.7% | Yes | 48.7% | 15% |

While Tables II illustrates a number of differences between the properties of the present raw base paper 110 and traditional silver halide raw base paper, as can be noted from the data, the raw base paper layer 110 produced according to present system and method exhibits a number of qualities that are either similar or better than the traditional silver halide raw base paper.

According to one exemplary embodiment, the present raw base paper layer 110 exhibits a formation level of about 110 to about 120 using a Kajaani Formation apparatus or about 0.25 to about 0.6 using an Ambertec beta formation tester, both of which test the optical properties of a raw base paper to analyze the uniformity of formation. Similarly, according to one exemplary embodiment, the present raw base paper layer 110 exhibits a smoothness value of about 2.0 to about 4.0 micrometers using a Park print surface method or about 20 to about 70 Sheffield Units (SU) using a Sheffield smoothness analysis. These formation levels and smoothness values are substantially similar to corresponding values of traditional silver halide raw base paper.

Porosity. To measure porosity the Gurley Porosity test method was used where 100 cc of air was allowed to pass through the samples and the time for its passage was measured. As can be noted from Table II, the sample Media II prepared embodying features of the invention had a lower Gurley Porosity number indicating a more porous medium as compared to control silver halide Media III.

The absorption rate of the samples were measured using Cobb test by placing each sample clamped in ring having an inside diameter of 100 cm² and providing a reservoir of water. The samples were let stand for two (2) minutes after which the remaining water was emptied from the ring. The samples were blotted to remove unabsorbed water and were weighed. As can be noted from Table II, the sample Media II prepared embodying features of the invention had a higher absorption capacity as compared to control silver halide Media III, as demonstrated by the higher amount of water absorbed per unit area.

The machine direction to cross-machine direction stiffness ratio of the samples were measured in order to assess the anisotropy in the raw base paper as well as the ratio of stress in the machine direction (same operation direction of the paper machine) to the cross-machine (perpendicular to the operation direction of the paper machine). As can be noted from Table II, in one embodiment which is represented by Media II, had a lower stiffness ratio which is believed to reduce the propensity of the final product (e.g. the coated photo inkjet paper) to curl, either or both before and after printing.

The brightness, CIE whiteness, and opacity of the samples, were measured using standard TAPPI Standards, 525, 560, and 425, respectively. As can be noted from the data in Table II, Media II, embodying features of the invention, had higher brightness, CIE whiteness, and opacity; than the control silver halide Media III. This increase suggests that a lower amount of additives, such as titanium dioxide, a relatively expensive additive, in the resin layer 120 and/or 130 may be reduced without negatively affecting these attributes, leading to a lower cost product having at least similar (and in some instances) better performance that the higher cost silver halide based products.

An exemplary forming method for forming the above-mentioned image supporting medium (100) will now be given in detail below.

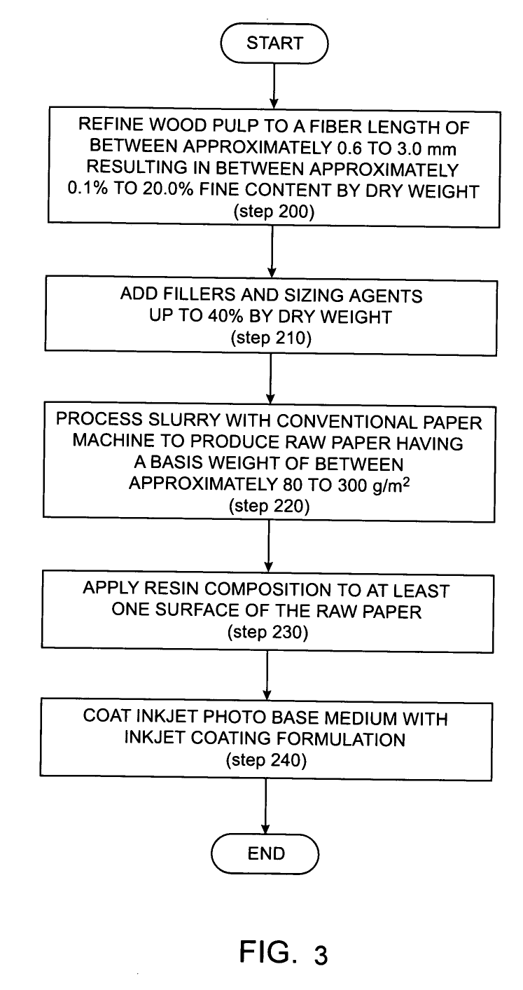

According to one exemplary embodiment, the film forming resin 120 (or 130) is coated on at least one side of the raw base paper layer 110. FIG. 3 illustrates one exemplary process for forming the raw base paper layer and or coating at least one side of the raw base paper layer, embodying features of the present invention, with a film forming resin. As illustrated in FIG. 3, the exemplary method for forming the image supporting medium 100 (see FIG. 1) begins with Step 200 by first refining a desired wood pulp to a weighted average fiber length ranging from about 0.5 and about 3.0 mm. According to one exemplary embodiment, refining desired wood pulp to a weighted average fiber length of between about 0.5 and about 3.0 mm entails any one of external and internal fibrillation, chopping the pulp, or beating the pulp. Additionally, various combinations of cutting beating and wet beating may be used according to the present exemplary embodiment. Once the wood pulp fibers have been refined to the desired length in step 200, in step 210 the fine content generated will range from about 0.0% to about 20.0% by dry weight of the wood pulp. As noted previously, the above-mentioned range of fine content is less than that of silver halide raw base paper (e.g., greater than 20% on dry basis). The reduction in the fine content of raw base paper according to the present invention configured for inkjet use as compared to the traditional silver halide raw base paper can enable higher paper machine speed. After the desired refining process in step 210 has been completed, fillers, sizing agents, and any additional desired additives may then be added to form up to about 40% by dry weight of the slurry in preparation of forming the desired raw base paper layer 110. According to one exemplary embodiment, mineral fillers are added to the slurry. According to this exemplary embodiment, any combination of calcium carbonate (CaCO3), Clay, gypsum (hydrated calcium sulfate), titanium oxide (TiO2), talc, alumina trihydrate, and/or magnesium oxide (MgO) is added to the slurry as fillers. Accordingly, the above-mentioned fillers may constitute up to about up to about 40 wt. %, generally from about 1 to about 40 wt. %, usually from 5 to about 35 wt. %, normally from about 10 to about 25 wt. % based on the basis weight of the raw base paper. In step 220, once the slurry is formed, it may be processed in a conventional paper machine to produce a raw base paper having a basis weight of between about 80 and 300 g/m², according to one exemplary embodiment. Traditional silver halide raw base papers must be formed on expensive paper machines constructed from stainless steel to avoid iron sensitization, a form of contamination. However, for the present exemplary system and method, the use of a stainless steel paper machine is not necessary and conventional paper machines (i.e. not stainless steel in construction) may be used. While the above-mentioned slurry may be processed at any number of processing rates, the low level of fine may allow the above-mentioned slurry to be processed at rates exceeding 600 ml/min, according to one exemplary embodiment. Once the raw base paper has been formed, it may then receive a resin composition on at least one of its surfaces to form the above-mentioned image supporting medium, 110, in step 230.

Once the image supporting medium has been formed in step 230, it may be coated with an inkjet coating formulation in step 240. According to one exemplary embodiment, inkjet coating formulations that may be used to coat the image receiving medium include, but not limited to, polyvinyl alcohols, silica, alumina, gelatins, polymers, and appropriate combinations thereof. Additionally, the inkjet coating formulation may comprise one or more layers. Furthermore, the one or more coated layers may be formed on one or more surfaces of the image supporting medium. Application of the inkjet coating formulation may be performed by any number of material dispensing means including, but in no way limited to, a slot die coating apparatus, a curtain coating apparatus, a blade coating apparatus, a roll coating apparatus, a gravure coating apparatus, and the like.

After the image supporting medium has received the inkjet formulation, the roll then undergoes a number of converting and packaging operations. According to one exemplary embodiment, the converting and packaging operations that may be performed on the resulting coated photo inkjet paper roll include, but not limited to, cutting, printing, and/or packaging steps that may be performed after the coated photo inkjet paper creation step illustrated in FIG. 3.

Once the inkjet coating formulation has been applied to the image supporting medium having the one or more resin coating thereon, it is prepared to receive an image via an inkjet material dispenser. Inkjet material dispensers that may be used to form images on the resulting photo base paper include, but are in no way limited to, thermally actuated inkjet dispensers, mechanically actuated inkjet dispensers, electrostatically actuated inkjet dispensers, magnetically actuated dispensers, piezoelectrically actuated dispensers, continuous inkjet dispensers, and the like.

As can be appreciated, the present system and method provide a low cost image supporting medium configured for use with inkjet image forming methods. More specifically, the inkjet image forming method allows for the use of a base paper incorporating virgin and/or recycled fibers ranging from about 0.5 to about 3.0 mm weighted average length, from a variety of woods or synthetic sources. Additionally, by relaxing the manufacturing constraints on the image forming medium and the available machines used to manufacture the image forming medium, initial cost of establishing a production facility is greatly reduced. Moreover, the present system and method allows fillers to be included in the present media base to reduce cost and improve the optical qualities of the resulting media base. Further, the use of the above-mentioned components facilitates the formation of a media base that is less susceptible to curl.

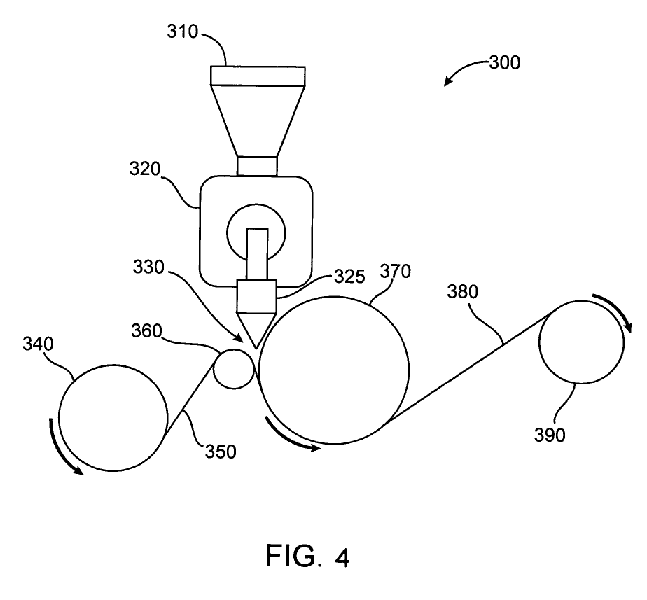

Now referring to FIG. 4, it illustrates the application of the resin composition onto a surface of the raw base paper using a resin applicator 300, according to one exemplary embodiment. As shown in FIG. 3, a raw base paper 350 is stored on a roll or pay-off 340. During the resin application process step 230 shown in FIG. 3, the raw base paper 350 is passed over a pressure roller 360 where it is positioned under a film die 325. As shown in FIG. 4, the film die 325 is fluidly coupled to a hopper 310 and an extruder 320 containing the desired resin. As the uncoated raw base paper 350 is passed adjacent to the film die 325, resin 330 is extruded onto the surface of the raw base paper 350. Once coated, the raw base paper and its new coating are processed by a chill roll 370. Surface finish of the chill roll 370 and the processing conditions of the resin applicator 300 determine the resulting surface finish and gloss of an image supporting medium 380 at given raw base paper. Additionally, a corona treatment may be utilized to enhance the adhesion of the resin 330 on the surface of the raw base paper 350. Additionally, after the resin coating is complete, a gelatin subbing layer may be applied to enhance the adhesion of photo inkjet coating formulation on the resin coated surface. Once coated, the substrate is collected by a windup roll 390 for storage until additional processes are performed thereon, such as inkjet formulation coating, cutting, printing, packaging, etc.

According to one exemplary embodiment of the present system and method, the roughness of the chill roll 370 may vary from about 0.25 micro inches to about 5 micro inches Ra (average roughness). As used herein, the average roughness Ra is measured as the sum of the absolute values of all the areas above and below a surface area mean line divided by the sampling length. It has been found that according to one exemplary embodiment, a chill roll 370 having the above-mentioned roughness produces a glossy surface that is configured for receiving an inkjet coating formulation. Additionally, a number of other process parameters may be varied to vary the final gloss of the resin coated base including, but in no way limited to, nip pressure, chill roll temperature, and melt temperature.

While the resin applicator 300 illustrated in FIG. 4 shows an extrusion apparatus providing a resin 330 on a single surface of the raw base paper 350, the above-mentioned system and method may also be used to provide a resin coating to a plurality of surfaces of the raw base paper 350. Moreover, any number of resin applicators may be used to provide the resin 330 on one or more surfaces of the raw base paper 350, including, but in not limited to, size press, tab size press, blade coating, air knife coating, extrusion coating, or the like.

While particular forms of the invention have been illustrated and described herein, it will be apparent that various modifications and improvements can be made to the invention. Moreover, individual features of embodiments of the invention may be shown in some drawings and not in others, but those skilled in the art will recognize that individual features of one embodiment of the invention can be combined with any or all the features of another embodiment. Accordingly, it is not intended that the invention be limited to the specific embodiments illustrated. It is intended that this invention to be defined by the scope of the appended claims as broadly as the prior art will permit.

Terms such a “element,” “member,” “component,” “device,” “section,” “portion,” “step,” “means,” and words of similar import, when used herein shall not be construed as invoking the provisions of 35 U.S.C. §112(6) unless the following claims expressly use the term “means” followed by a particular function without specific structure or the term “step” followed by a particular function without specific action. Accordingly, it is not intended that the invention be limited, except as by the appended claims. All patents and patent applications referred to herein are hereby incorporated by reference in their entirety.

What is claimed is:

1. An image supporting medium comprising:
a. a raw base paper having a plurality of formation scales (FS) including a basic formation scale ranging from about 0.5 to 12.0 mm, the basic scale including a plurality of formation scales ranging from about 0.5 to about 0.7 mm (“C1”), from about 0.7 to about 1.1 mm (“C2”), from about 1.1 to about 1.8 mm (“C3”), from about 1.8 to about 2.6 mm (“C4”), from about 2.6 to about 4.5 (“C5”), from about 4.5 to about 6.7 (“C6”), and from about 6.7 to about 12.0 mm (“C7”); and a minimum formation value for each of the scales of formation C2 through C6 is, independently, being at least about 65 or at least about 70, at least about 50 or at least about 60, at least about 55 or at least about 60, at least about 60 or at least about 70, and at least about 70 or at least about 80, respectively;
b. at least one filler; and
c. a film forming resin disposed on at least one side of the raw base paper.

2. An image supporting medium according to claim 1, wherein the minimum formation value for each of the scales of formation C1 and C7 is, independently, at least about 105 or at least about 110, and at least about 65 or at least about 70, respectively.

3. An image supporting medium according to claim 1, wherein the raw base paper meets the minimum formation values of each of the stated formation scale ranges.

4. An image supporting medium according to claim 2 wherein the raw base paper meets the minimum formation values of each of the stated formation scale ranges.

5. An image supporting medium according to claim 1, wherein the image supporting medium has at least a gloss of about 60% at 200 reflection angle.

6. An image supporting medium according to claim 1 wherein the image supporting medium has a gloss of at least about 50% at 20° reflection angle.

7. An image supporting medium according to claim 1 wherein the image supporting medium has a gloss of at least about 40% at 20° reflection angle.

8. An image supporting medium according to any one of claims 1, 2, 3, or 4, wherein, the gloss of the image supporting medium is relatively greater than by about 10 to about 15% at 200 reflection angle, as compared to an otherwise similar image supporting having formation values less than the stated minimum PPFV.

9. The image supporting medium on any of claims 1 through 7, wherein the raw base paper has a moisture content up to about 8.5 wt. %, as compared to the basis weight of the raw base paper.

10. An image supporting medium according to claim 9, wherein, the gloss of the image supporting medium is relatively greater than by about 10 to about 15% at 200 reflection angle, as compared to an otherwise similar image supporting having formation values less than the stated minimum PPFV.

11. An image supporting medium according to claim 9, wherein the raw base paper has a moisture content of 8.0 wt. % or less.

12. An image supporting medium according to claim 9, wherein the raw base paper has a moisture content of up to about 8.0 wt. %.

13. An image supporting medium according to claim 9, wherein the raw base paper has a moisture content moisture content of 7.5 wt. % or less.

14. An image supporting medium according to claim 9, wherein the raw base paper has a moisture content of ranging from about 6.0 to about 7.0 wt. %.

15. An image supporting medium according to claim 9, wherein the raw base paper comprises at least one filler in an amount ranging from about 1 to about 40 wt. % as compared to the basis weight of the raw base paper.

16. An image supporting medium according to claim 9, wherein the raw base paper comprises at least one filler in an amount ranging from about 5 to about 35 wt. % as compared to the total as compared to the basis weight of the raw base paper.

17. An image supporting medium according to claim 9, wherein the raw base paper comprises at least one filler in an amount ranging from about 10 to about 25 wt. % as compared to the basis weight of the raw base paper.

18. An image supporting medium according to claim 12, wherein, the gloss of the image supporting medium is relatively greater than by about 10 to about 15% at 20° reflection angle, as compared to an otherwise similar image supporting having formation values less than the stated minimum PPFV.

19. An image supporting medium according to claim 15, wherein, the gloss of the image supporting medium is relatively greater than by about 10 to about 15% at 200 reflection angle, as compared to an otherwise similar image supporting having formation values less than the stated minimum PPFV.

20. An image supporting medium according claim 17, wherein, the gloss of the image supporting medium is relatively greater than by about 10 to about 15% at 200 reflection angle, as compared to an otherwise similar image supporting having formation values less than the stated minimum PPFV.

21. An image supporting medium according to claim 9, wherein the at least one filler is selected from the group consisting of calcium carbonate, clay, kaolin, gypsum, titanium oxide, talc, alumina trihydrate, magnesium oxide, or any combination thereof.

22. An image supporting medium according to claim 9 wherein the at least one filler comprises calcium carbonate.

23. The image supporting medium of claim 9, wherein the film forming resin comprises a thermoplastic resin.

24. An image supporting medium according to claim 9 wherein the resin is selected from the group consisting of polyolefin resin, a polycarbonate resin, a polyester resin, or a polyamide resin.

25. An image supporting medium according to claim 9 wherein the resin is a polyethylene resin.

26. An image supporting medium, comprising:
a. a raw base paper having at least one filler in an amount ranging from about 1 to about 40 wt. % as compared to the basis weight of the raw base paper, and a moisture content of up to about 8.5 wt. % as compared to the basis weight of the raw base paper; and
b. a film forming resin disposed on at least one side of the raw base paper.

27. An image supporting medium according to claim 26, wherein the raw base paper has a moisture content of 8.0 wt. % or less.

28. An image supporting medium according to claim 26, wherein the raw base paper has a moisture content of up to about 8.0 wt. %.

29. An image supporting medium according to claim 26, wherein the raw base paper has a moisture content of about 7.5 wt. % or less.

30. An image supporting medium according to claim 26, wherein the raw base paper has a moisture content ranging from about 6.0 to about 7.0 wt. %.

31. An image supporting medium according to any of claims 26 through 30, wherein the at least one filler ranges from about 10 to about 25 wt. %

32. An image supporting medium according to claim 26, wherein the at least one filler is selected from the group consisting of calcium carbonate, clay, kaolin, gypsum, titanium oxide, talc, alumina trihydrate, magnesium oxide, or any combination thereof.

33. An image supporting medium according to claim 26, wherein the at least one filler comprises calcium carbonate.

34. An image supporting medium according to any of claims 26 through 30, wherein the image supporting medium has a gloss of about 60% at 200 reflection angle.

35. An image supporting medium according to claim 34, wherein the image supporting medium has a gloss of about 50% at 200 reflection angle.

36. An image supporting medium according to claim 34, wherein the image supporting medium has a gloss of about 40% at 200 reflection angle.

37. An image supporting medium according to claim 30, wherein the film forming resin comprises a thermoplastic resin.

38. An image supporting medium according to claim 26, wherein the resin is selected from the group consisting of polyolefin resin, a polycarbonate resin, a polyester resin, or a polyamide resin.

39. An image supporting medium according to claim 26, wherein the resin is a polyethylene resin.

40. A method for forming an image supporting medium comprising:
a. forming a raw base paper having a plurality of formation scales (“FS”) according to the raw base paper of claim 1; and
b. coating at least one side of the raw base paper with a film forming resin.

41. A method according to claim 40, wherein the minimum formation value for each of the scales of formations C1 and C7 independently, is at least about 105 or at least about 110, and at least about 65 or at least about 70, respectively.

42. A method according to claim 40, wherein the raw base paper meets the minimum formation values of each of the stated formation scale ranges.

43. A method according to claim 41 wherein the raw base paper meets the minimum formation values of each of the stated formation scale ranges.

44. A method according to any of claims 40 through 43, wherein the step of forming the raw base paper comprises:
a. processing a desired wood pulp;
b. providing from about 1 to about 40 wt. % filler as compared to as compared to the basis weight of the raw base paper;
c. processing the pulp and filler into a slurry; and
d. processing the slurry to produce a raw base paper having a moisture content of up to about 8.5 wt. % as compared to the as compared to the basis weight of the raw base paper.

45. The method of claim 44, wherein the moisture content ranges from 6 to about 8.0 wt. %

46. A method according to any one of claims 44 or 45, wherein the filler ranges from about 10 to about 25 wt. %.

47. A method according to claim 44 further comprising applying an inkjet formulation adjacent the film forming resin.

48. A method for forming an image supporting medium comprising:
a. a raw base paper having a moisture content of up to about 8.5 wt. % as compared to the as compared to the basis weight of the raw base paper; and
b. coating at least one side of the raw base paper with a film forming resin.

49. A method according to claim 48, wherein the step of forming the raw base paper comprises:
a. processing a desired wood pulp;
b. providing from about 1 to about 40 wt. % filler as compared to the basis weight of the raw base paper;
c. processing the pulp and filler into a slurry; and
d. processing the slurry to produce the raw base paper having a moisture content of up to about 8.5 wt. % as compared to the basis weight of the raw base paper.

50. The method of claim 49 wherein the moisture content ranges from 6 to about 8.0 wt. %

51. A method according to any one of claim 48, 49, or 50, wherein the filler content ranges from about 10 to about 25%.

52. A method according to claim 48 further comprising applying an inkjet formulation adjacent the film forming resin.

53. A coated inkjet photo paper comprising:
a. a raw base paper having a plurality of formation scales (“FS”) according to the raw base paper of claim 1;
b. a film forming resin disposed on at least one side of the raw base paper.

54. A coated inkjet photo paper according to claim 53, further comprising an inkjet compatible coating disposed adjacent the film forming resin.

55. A coated inkjet photo paper comprising:
a. a raw base paper having at least one filler in an amount ranging from about 1 to about 40 wt. % as compared to as compared to the basis weight of the raw base paper, and a moisture content of up to about 8.5 wt. % as compared to the basis weight of the raw base paper, together forming a slurry; and
b. a film forming resin disposed on at least one side of the raw base paper.

56. An inkjet coated paper according to claim 55 wherein the filler ranges from about 10 to abut 25% by dry weigh of the slurry and the moisture content up to about 8.0%.

57. An inkjet photo paper of claim 55, further comprising an inkjet compatible coating disposed adjacent the film forming resin.
